(19) United States
(12) Patent Application Publication
(10) Pub. No.: US 2006/0008494 A1
(43) Pub. Date: Jan. 12, 2006

(54) Complete inactivation of infectious proteins

(75) Inventor: Stanley B. Prusiner, San Francisco, CA (US)

Correspondence Address: BOZICEVIC, FIELD & FRANCIS LLP, 1900 UNIVERSITY AVENUE, SUITE 200, EAST PALO ALTO, CA, 94303, US

(73) Assignee: The Regents of the University of California

(21) Appl. No.: 11/157,488

(22) Filed: Jun. 20, 2005

Related U.S. Application Data
(63) Continuation-in-part of application No. 10/735,454, filed on Dec. 12, 2003.
Application No. 10/735,454 is a continuation of application No. 10/056,222, filed on Jan. 22, 2002, now Pat. No. 6,720,355.
Application No. 10/056,222 is a continuation-in-part of application No. 09/904,178, filed on Jul. 11, 2001, now Pat. No. 6,719,988.
Application No. 09/904,178 is a continuation-in-part of application No. 09/699,284, filed on Oct. 26, 2000, now abandoned.
Application No. 09/699,284 is a continuation-in-part of application No. 09/494,814, filed on Jan. 31, 2000, now Pat. No. 6,322,802.
Application No. 09/494,814 is a continuation-in-part of application No. 09/447,456, filed on Nov. 22, 1999, now Pat. No. 6,331,296.
(63) Continuation-in-part of application No. 09/406,972, filed on Sep. 28, 1999, now Pat. No. 6,419,916.
Application No. 09/406,972 is a continuation-in-part of application No. 09/322,903, filed on Jun. 1, 1999, now Pat. No. 6,214,366.
Application No. 10/735,454 is a continuation-in-part of application No. 09/322,903, filed on Jun. 1, 1999, now Pat. No. 6,214,366.
(63) Continuation-in-part of application No. 09/235,372, filed on Jan. 20, 1999, now Pat. No. 6,221,614.
Application No. 09/235,372 is a continuation-in-part of application No. 09/151,057, filed on Sep. 10, 1998, now abandoned.
Application No. 09/151,057 is a continuation-in-part of application No. 09/026,957, filed on Feb. 20, 1998, now abandoned.
Application No. 09/026,957 is a continuation-in-part of application No. 08/804,536, filed on Feb. 21, 1997, now Pat. No. 5,891,641.
(60) Provisional application No. 60/618,115, filed on Oct. 12, 2004.
(60) Provisional application No. 60/581,921, filed on Jun. 21, 2004.

(51) Int. Cl. A01N 25/00; A01N 37/00

(52) U.S. Cl. 424/405; 514/553

(57) ABSTRACT

The invention comprises a formulation and a method which uses the formulation. The formulation is comprised of an aqueous or alcohol solvent having therein (1) a detergent such as SDS; (2) a weak acid such as acetic acid; and (3) a chemical modification reagent such as hydrogen peroxide. The formulation can be modified to substitute other detergents for the SDS, other acids for the acetic acid and other oxidants for the peroxide provided the substitute results in a total formulation which completely inactivates the infectivity of infectious proteins such as prions in a relatively short period of time (e.g. less than two hours) and under relatively mild temperatures (e.g. 60° C. or less).

### CROSS-REFERENCE

This application claims priority to provisional Application Ser. No. 60/618,115, filed Oct. 12, 2004 which claims priority to provisional Application Ser. No. 60/581,921, filed Jun. 21, 2004 and is a continuation-in-part application of U.S. application Ser. No. 10/735,454, filed Dec. 12, 2003, which application is a continuation of U.S. application Ser. No. 10/056,222, filed Jan. 22, 2002 now U.S. Pat. No. 6,720,355 issued Apr. 13, 2004, which is a continuation-in-part of U.S. application Ser. No. 09/904,178, filed Jul. 11, 2001 now U.S. Pat. No. 6,719,988 issued Apr. 13, 2004, which is a continuation-in-part of U.S. application Ser. No. 09/699,284, filed Oct. 26, 2000 now abandoned, which is a continuation-in-part of U.S. application Ser. No. 09/494,814, filed Jan. 31, 2000, now U.S. Pat. No. 6,322,802, which is a continuation-in-part of U.S. application Ser. No. 09/447,456, filed Nov. 22, 1999 now U.S. Pat. No. 6,331,296, and also is a continuation-in-part of U.S. application Ser. No. 09/406,972, filed Sep. 28, 1999 now U.S. Pat. No. 6,419,916, both of which are a continuation-in-parts of U.S. application Ser. No. 09/322,903, filed Jun. 1, 1999, now U.S. Pat. No. 6,214,366 and to which priority is claimed under 35 U.S.C. §§ 120 and 119. This application is also a continuation-in-part of U.S. application Ser. No. 09/235,372, filed Jan. 20, 1999, now U.S. Pat. No. 6,221,614, issued Apr. 24, 2001, which is a continuation-in-part of U.S. application Ser. No. 09/151,057, filed on Sep. 10, 1998, now abandoned, which is a continuation-in-part of U.S. application Ser. No. 09/026,957, filed on Feb. 20, 1998, now abandoned, which is a continuation-in-part of U.S. application Ser. No. 08/804,536, filed on Feb. 21, 1997, now U.S. Pat. No. 5,891,641, all of which applications are incorporated herein by reference and to which applications priority is claimed under 35 U.S.C. §§ 120 and 119. The current disclosure is controlling to the extent it conflicts with an earlier disclosure.

### GOVERNMENT RIGHTS

This invention was made with government support under federal grant nos. AG02132, AG08967, AG10770, NS02048, and NS14069 awarded by The National Institutes of Health. The United States Government may have certain rights in this invention.

### FIELD OF THE INVENTION

This invention relates generally to the field of disinfectants and more particularly to disinfectants for inactivating the infectivity of infectious proteins.

### BACKGROUND OF THE INVENTION

The prion diseases including Creutzfeldt Jakob Disease (CJD) in humans, bovine spongiform encephalopathy (BSE) in cattle, and scrapie in sheep are fatal neurodegenerative illnesses caused by infectious pathogens designated prions. More than 200 documented cases of iatrogenic CJD have been caused by inadequate disinfection of pituitary extract-derived hormone supplements, dura mater and corneal grafts, and neurosurgical equipment. Epidemiological evidence suggests that CJD might also be transmitted by surgical procedures outside the CNS. Conventional hospital disinfectants including ethylene oxide, propriolactone, hydrogen peroxide, iodophors, peractic acid, chaotropes and phenolics have little effect on prion infectivity. In addition, infectious prions are resistant to UV irradiation, aldehyde fixation, boiling, standard gravity autoclaving at 121° C., and detergent solubilization.

Currently recommended protocols for prion decontamination include either: (i) >2% available chlorine of sodium hypochlorite for 2 h, (ii) 2 M sodium hydroxide for 1 h, or (iii) autoclaving at 134° C. for 4.5 h. Each of these protocols has important limitations: sodium hypochlorite is corrosive at the concentrations required to inactivate prions; sodium hydroxide is also corrosive and does not inactivate CJD prions completely; autoclaving is time-consuming, cannot be used with heat-sensitive or complex materials, and generates dried macerated tissue resistant to inactivation. Because of these limitations, prion decontamination of surgical or dental equipment is performed only after operations on patients suspected to have CJD. Standard protocols used to sterilize instruments following operations on all other patients, such as routine autoclaving or bath sonication, do not inactivate prions. Therefore, a practicable method for routine prion decontamination of all surgical instruments is urgently needed to prevent cases of iatrogenic CJD resulting from failure to suspect prion disease in surgical or dental patients.

The anionic (negatively charge) detergent sodium dodecyl sulfate (SDS) is a particularly attractive candidate for use as a surface prion disinfectant because it is (1) denaturing to prions under certain conditions, (2) non-corrosive to metals, and (3) inexpensive. However, previous attempts to disinfect prions with neutral solutions of SDS yielded mixed results. In some experiments, 3% SDS at neutral pH reportedly destroyed prion infectivity in brain homogenates when samples were boiled or autoclaved. In other experiments, boiling brain homogenates in 2% SDS at neutral pH did not substantially reduce prion infectivity. Furthermore, prion infectivity in macerated brain samples survived boiling for 15 min in 5% SDS at neutral pH. This evidence suggests that SDS solutions at neutral pH, even at high temperatures, cannot be used reliably for prion decontamination.

### SUMMARY OF THE INVENTION

The invention comprises a formulation and a method which uses the formulation. The formulation is comprised of an aqueous or alcohol solvent having therein (1) a detergent such as SDS; (2) a weak acid such acetic acid; and (3) chemical modification reagent such as hydrogen peroxide. The formulation can be modified to substitute other detergents for the SDS and other acids for the acetic acid provided the substitute results in a total formulation which completely inactivates the infectivity of infectious proteins such as prions in a relatively short period of time (e.g. less than two hours) and under relatively mild temperatures (e.g. 60° C. or less) and a relatively mild pH range of about 2.5 to 4.0.

An aspect of the invention is the chemical modification reagent, which is any chemical that covalently modifies one or more of the side chains of amino acids in an infectious protein such as prions. Hydrogen peroxide and peracetic acid are examples of such chemical reagents that oxidize amino acid side chains.

An aspect of the invention is that it is comprised of relatively low concentration of relatively common and inexpensive components.

An aspect of the present invention is a mixture of the cationic detergent CTAB and other detergents, with an oxidizing reagent such as peracetic acid in concentrations and proportions which denature PrP^{Sc} completely in a short period of time under mild conditions. Mixtures and/or solutions of the invention provide a non-corrosive and yet a more robust prion disinfectant suitable for routine use in surgical decontamination, animal rendering, and related fields.

The formulation of the invention may be comprised of, consist of, or consist essentially of a detergent, a weak acid and a chemical modification reagent and a solvent. The detergent is preferably sodium dodecyl sulfate (SDS) or cetylmethylammonium bromide (CTAB). It should be noted that SDS can be referred to as sodium dodecyl sulfinate which is a twelve carbon alkyl salt of sulfonic or sulfuric acid. The weak acid component may be an acid such as acetic acid or peracetic acid which maintains the pH at about 4.0 or less or in a range of about 2.5 to 4.0. It is desirable to maintain the pH below 4.0 but not to reduce the pH so low such that when the formulation is used on metal surfaces such as surgical instruments it causes damage to those instruments. The composition may include a solvent such as water or alcohol and the chemical modification reagent may be hydrogen peroxide which may be liquid, gaseous, or in a plasma form.

The method of the invention applies the formulation to surfaces which may be infected with infectious proteins such as prions and results in the complete inactivation of those proteins. The method comprises contacting the infectious protein such as prions with a formulation of the invention for a period of time and under conditions so as to completely inactivate the infectivity of the protein. An important aspect of the invention is to completely inactivate the infectivity of the proteins in a relatively short period of time, e.g. 2 hours or less, or 1 hour or less. Another aspect of the invention is the inactivation of the infectious protein such as prions under relatively mild conditions such as at a temperature, pH and other conditions which do not adversely effect surfaces such as medical devices and surgical components which might be contacted with the formulation in order to inactivate infectious proteins present on their surfaces. Thus, the temperature may be relatively high such as approximately 130° C. to 140° C. used in autoclaving but may be relatively low such as less than 100° C. or even less than 80° C. or less than 60° C. and still obtain the objects of the invention which include complete inactivation of the infectious proteins. Further, the pH may be relatively low but can be in a range of about 2.5 to 4.0 and still achieve the objects of the invention of complete prion inactivation.

These and other objects, advantages, and features of the invention will become apparent to those persons skilled in the art upon reading the details of the formulation and method as more fully described below.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a graph of the percent survival versus incubation time in days.

FIG. 2 includes FIG. 2A showing an image of gels over a range of different pHs and FIG. 2B showing gels as described further within Example 2 and FIG. 2C showing gels with and without acetic acid as described further in Example 2.

FIG. 3 includes FIG. 3A showing gels or different formulations were applied and to the different lanes as described further within Example 3 with a bar graph of the results shown in FIG. 3B.

FIG. 4 includes FIG. 4A showing a gel with film exposed for 15 seconds and FIG. 4B showing the film exposed for 10 minutes as described further within Example 4.

FIG. 5 includes two gels with the lanes described at the bottom of FIG. 5 and a further description provided within Example 5.

FIG. 6 includes the gel of FIG. 6A and the resulting bar graph of FIG. 6B with the Figures described further within Example 6.

FIG. 7 includes a six lane gel with the different formulations used as shown in the description at the bottom of FIG. 7 with the image further described within Example 7.

FIG. 8 includes an image of 14 lanes exposed to different formulations described at the bottom of FIG. 8 with a further description provided within Example 8.

FIG. 9 includes two gels of five lanes each using different antibodies as described within Example 9.

FIG. 10 includes the gel of FIG. 10A and gel of FIG. 10B as described further within Example 10.

FIG. 11 includes two gels as described further within Example 11.

### DETAILED DESCRIPTION OF THE INVENTION

Before the present method and formulations are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a detergent” includes a plurality of such detergents and reference to “the acid” includes reference to one or more acids and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Invention in General

The invention relates to formulations and methods for inactivating the infectivity of infectious proteins such as prions. The invention results in total or complete inactivation of the infectious nature of the protein such as prions or PrP^{Sc} and does so under mild pH and temperature conditions. Thus, the formulations and methods can be used in a wide range of environments without having destructive or damaging effects on the instruments or environments contacted with a formulation of the invention. The formulation may be comprised of multiple components. A typical formulation is comprised of a solvent such as water and/or alcohol such as methanol or ethanol having three active components therein. The three active components are, for example, (1) a detergent such as sodium dodecyl sulfate (SDS) and/or cetylmethylammonium bromide (CTAB); (2) a weak acid such as acetic acid or peracetic acid; and (3) a chemical modification reagent such as hydrogen peroxide. The active components may be applied together or sequentially with the detergent applied first.

The invention may be in the form of a method of disinfecting which method may use the formulation or may use individual components of the formulation in sequence. For example, the detergent may be applied to the protein such as prions. Thereafter, the weak acid is applied. Thereafter the chemical modification reagent is applied. Each step may be carried out under relatively mild conditions, e.g. a temperature in a range of about 10° C. to about 80° C. or 15° C. to 60° C. for two hours or less for each step or for all the steps combined.

In connection with either the method or the formulation of the invention results may be obtained using the detergent with only the weak acid or with only the chemical modification reagent. However, results are improved when all three components are used.

Without relying on a particular theory or mechanism of action it is believed the formulations of the invention operate on infectious proteins such as prions by (1) causing a change in the protein's conformation, i.e. the manner in which the chain of amino acids fold; and (2) chemically modifying one or more amino acids in the chain resulting in a modified chain which is incapable of refolding into its infectious conformation. Although the active components may interact to obtain these results the detergent is generally changing the initial conformation and the acid and/or the peroxide are generally responsible for chemically altering one or more of the amino acids.

### Infectious Proteins

Farm animals in United Kingdom were fed meat and bone meal during the BSE epidemic. Accordingly, the possibility that BSE may have passed to flocks of sheep and goats is a real concern. If BSE has been transmitted to sheep, this could pose serious risk to humans and livestock since BSE prions seem capable of infecting a broad range of mammal species. More tissues are infectious in sheep than in cattle, and prions seem to spread within the sheep population without much difficulty. In order to determine whether BSE has been passed to sheep, homogenate from sheep experimentally infected with BSE prions were passaged to mice. This resulted in an incubation time and lesion profile similar to those caused by homogenates of cattle with BSE. However, large-scale screening of tens of thousands of sheep by this approach seems unpractical. The inventive results provided here show that a formulation of SDS and peroxygenic compounds at low pH can discriminate between some strains of the same species. Differences could be discriminated in western blot and ELISA setting using antibodies against residues 95-112. This finding shows that other prions strains including scrapie and BSE in sheep can be discriminated using this approach.

The present invention shows that chemical modification reagents such as oxidizing agents boost the denaturation effect of SDS at low pH. Combinations of these three components are more potent than any two at denaturing PrP^{Sc}. Peracetic acid and hydrogen peroxide are currently used as general microbial disinfectant [Rutala, W. A. (1996). “APIC guideline for selection and use of disinfectants.” Amer. J. Infect. Control 24: 313-342]. A combination of these two compounds with acidic SDS provides a very broad spectrum of disinfecting activity. Addition of metal ions promotes the formation of hydroxyl radical and antimicrobial activity, and therefore, further enhances denaturation of PrP^{Sc}. This finding shows that effective denaturation of PrP^{Sc} is achieved at temperatures suitable for heat sensitive devices.

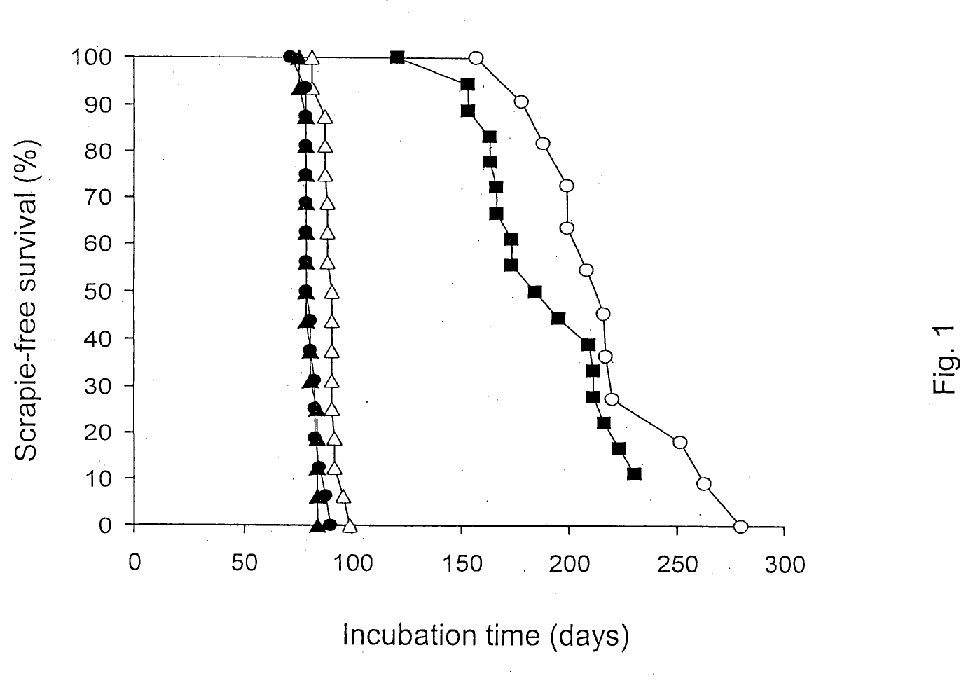

The anionic detergent SDS at low pH will denature PrP^{Sc}. To confirm that denaturation of PrP^{Sc} caused by acidic SDS correlates with reduction in prion infectivity, Sc237-infected SHa brain homogenates were incubated for 2 h in different buffer conditions at various temperatures to provide treated samples that were injected intracerebrally into indicator Syrian hamsters. Inoculation of a control brain homogenate sample containing 10⁷ ID₅₀ units Sc237 prions/ml at neutral pH without detergent caused scrapie in 16 of 16 indicator animals in 79±1 days. The results are plotted in the solid triangles of FIG. 1. Indicator animals inoculated with parallel samples exposed to either 0.5% acetic acid or 1% SDS alone at 37° C. developed scrapie in 82±1 and 91±2 days, respectively. These results are shown respectively by the solid circles and open triangles of FIG. 1. In contrast, exposure of the inoculum to a combination of 0.5% acetic acid and 1% SDS for 2 h at 37° C. prolonged the mean scrapie incubation time to 210±12 days. This data is plotted in FIG. 1 with the open circles. Decreasing the incubation temperature for exposure to acidic SDS to 20° C. resulted in a mean scrapie incubation time of ˜175 days and this data is plotted in FIG. 1 with the solid squares. These data suggest that acidic SDS at room temperature or 37° C. will not be effective in eliminating all prion infectivity. However, there is clearly a need to develop a safe and effective means for more robust inactivation of prions in settings were high temperature and/or extreme pH conditions are not an option.

The oxidizing solution hydrogen peroxide (HP, H₂O₂) by itself does not disinfect prions [Brown, P., R. G. Rohwer, et al. (1982). “Effect of chemicals, heat, and histopathologic processing on high-infectivity hamster-adapted scrapie virus.” J. Infect. Dis. 145: 683-687]. Consistent with this it is pointed out that H₂O₂ does not denature PrP^{Sc}. The present invention show that H₂O₂ by itself under mild conditions in the presence of SDS at low pH effectively denatures PrP^{Sc} rendering them completely non-infectious under mild conditions. Hydrogen peroxide is also effective in killing and/or inactivating a wide range of organisms: bacteria, yeast, fungi, viruses, and spores. Peroxygen compounds. Disinfection, Sterilization, and Preservation. S. S. Block. Philadelphia, Lippincott Williams & Wilkins: 185-204 (2001)]. The present invention shows that oxidizing reagents and acidic SDS act synergistically to denature prions rendering them completely non-infectious under mild conditions. Further, the present invention shows that the combination of acidic SDS and oxidizing reagents possess a very broad spectrum of disinfecting activity.

Acidic SDS and Hydrogen Peroxide Synergies to Denature PrP^{Sc}

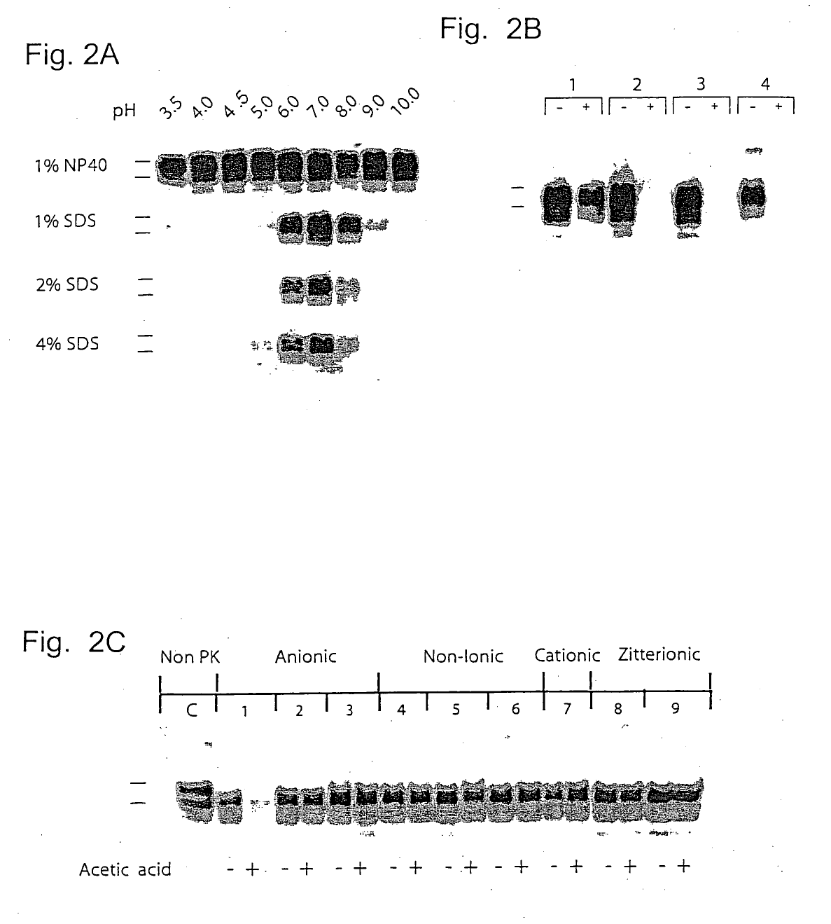

FIG. 2A provides immunoblots showing that aqueous solutions of ≧1% SDS denature PrP^{Sc} completely at pH values ≦4.5 or ≧10.0 following limited proteolysis. FIG. 2C shows that other detergents at low pH do not denature PrP^{Sc}. Acidic buffers other than acetic acid synergize with SDS to denature PrP^{Sc}. Samples of Sc237-infected SHa brain homogenates were incubated with 1% SDS plus 0.5% acetic acid, pH 3.6; 50 mM glycine, pH 3.7; or 0.2% peracetic acid, pH 3.4 for 15 min at 37° C. The results in the immunoblots of FIG. 2B show that PrP^{Sc} was denatured in the presence of each of these acidic buffers.

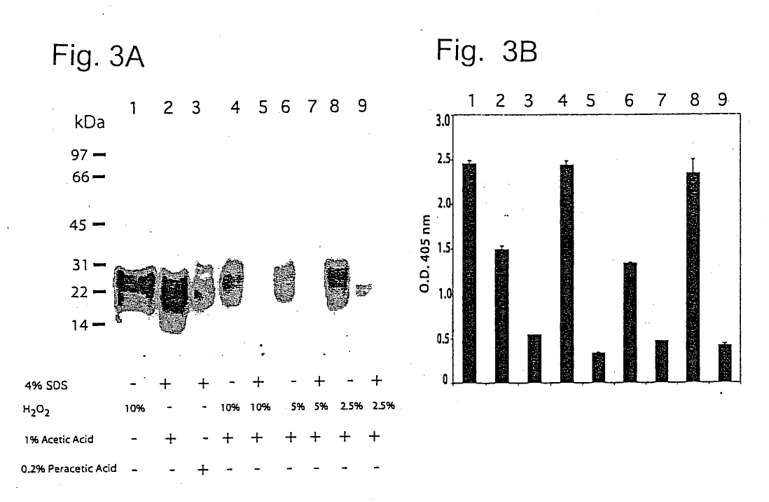

The Western blot ELISA of FIG. 3A and bar graph of FIG. 3B shows that 0.2% peracetic acid (PAA) and 4% SDS is three times more effective in denaturating PrP^{Sc} as compared to 1% acetic acid and 4% SDS following limited proteolysis (compare lanes 2 and 3). This is a surprising result since both SDS solutions are at low pH. As peracetic acid (PAA) is formed by addition of reactive oxygen to acetic acid by H₂O₂ these results show that oxidation of PrP^{Sc} augments its denaturation by acidic SDS. The reaction of acetic acid to peracetic acid is shown below.

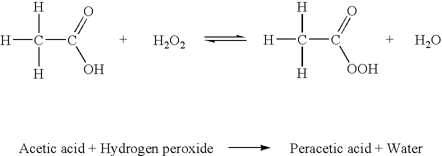

The effect of the oxidizer hydrogen peroxide (H₂O₂) on Sc237-infected SHa brain homogenates at room temperature was examined. It was found that 10% HP does not denature PrP^{Sc} and these results are shown in lane 1 of FIG. 3A. This is consistent with previous study where treatment with 3% HP was not shown to diminish prion infectivity [Brown, P., R. G. Rohwer, et al. (1982). “Effect of chemicals, heat, and histopathologic processing on high-infectivity hamster-adapted scrapie virus.” J. Infect. Dis. 145: 683-687]. However, a comparison of lanes 1 and 2 of FIG. 3B shows that the combination of both acetic acid and SDS (4% SDS, 1% acetic acid) do denature PrP^{Sc}. Further, FIG. 3B lane 4 shows that 10% HP in the presence of 1% acetic acid does not denature PrP^{Sc} either. Further, lanes 5, 7 and 9 of FIG. 3B show that a solution formulation of 4% SDS, 1% acetic acid and 2.5-10% HP was highly effective in denaturating PrP^{Sc}. A mixture of acidic SDS and oxidizing reagent is a more efficient denaturant as compared to any of these acidic SDS solutions (FIG. 3B; compare lane 2 to lanes 3, 5, 7, and 9). These results shown in FIGS. 3A and 3B indicate that combination of (1) oxidizing reagents; (2) acetic acid; and (3) SDS synergizes to denature PrP^{Sc} and therefore are more effective than the combination of acetic acid and SDS.

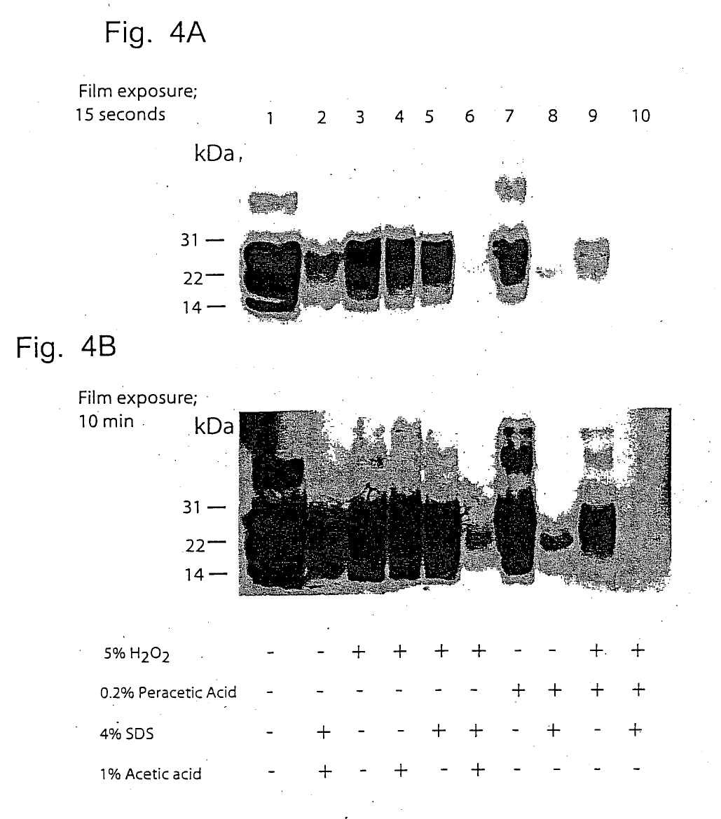

FIG. 4 shows the results of another set of experiments carried out to determine the efficacy of different formulations of acetic acid, SDS, and peroxygen compounds at room temperature. These results show that formulations of SDS and acetic acid were a more effective denaturant as compared to any of: 1) hydrogen peroxide (HP), 2) HP/acetic acid, 3) HP/SDS, and 4) PA (FIG. 4A compare lanes 2, 4, 5, and 7, respectively). Treatment with a mixture of oxidizing reagents; HP/PA was more effective than acidic SDS, but some residual PrP^{Sc} was detected (FIG. 4A lanes 2 and 9). Mixtures of SDS and oxidizing compounds (PA and HP) at low pH are clearly more effective as compared to SDS at low pH (FIG. 4A compare lanes 6, 8, and 10 to lane 2). Of the tested formulations the combination SDS, peracetic acid and HP was shown to be the most potent denaturant (FIG. 4B lane 10).

### Examples of Active Components

In addition to the detergent there is an active component of the invention which may be either or both of a chemical modification reagent and a weak acid such as acetic acid and peracetic acid. Other acids such as perfomic acid, iodoacetic acid, nitrous acid, p-sulfondichloramindobenzoic acid, trichloro-isocyanuric acid, and dichloro-isocyanuric acid can be used. The acid should be present in an amount and molarity so as to maintain the pH of the formulation in a range of about 5.0 to about 3.0, or less than about 4.0. In another embodiment the acid may be replaced with a base component present in an amount and molarity to obtain a pH of the formulation of about 9.0 or more, or about 8.0 to about 10.0.

The third active component is the chemical modification reagent. Such may be hydrogen peroxide added as a liquid, gas or plasma. However, a list of useful chemical modification reagents is provided below:

TABLE 1
Chemical modification reagents

Hydrogen Peroxide
N-Succinimdyl propionate
Diethylpyrocarbonate
Formaldehyde
Glutaraldehyde
Iodine
Maleic anhydride
Dithiothreitol (DTT)
Sodium borohydride
Succinic anhydride
Acetic anhydride
Maleic anhydride
Sulfonyl halides
Carbodiimide
Diazonium salts
Iodoacetate
Sulfites
Phosphorothioate
5,5′-Dithiobis(2-Nitrobenzoic acid) (DTNB)
Iodosobenzoate
Tetrathionate
N-bromosuccinamide (NBS)
N-bromoacetamide
Tetranitromethane
Cyanogen bromide
Hypochlorites
Chlorinated trisodium phosphate
Chlorine dioxide
N,N′-dichloroazodicarbonamidine
Sulfonchloramide
Succinchlorimide
1,3-Dichloro-5,5-dimethylhydantoin
Trichloromelamine
Ozone
Chlorine
Phenylglyoxal
Nitriles
Pyridines
Thiazoles
Ortho-phthaldehyde
Nitric oxide
Beta-propiolactone
N-ethylmaleimide

H₂O₂ and Detergents

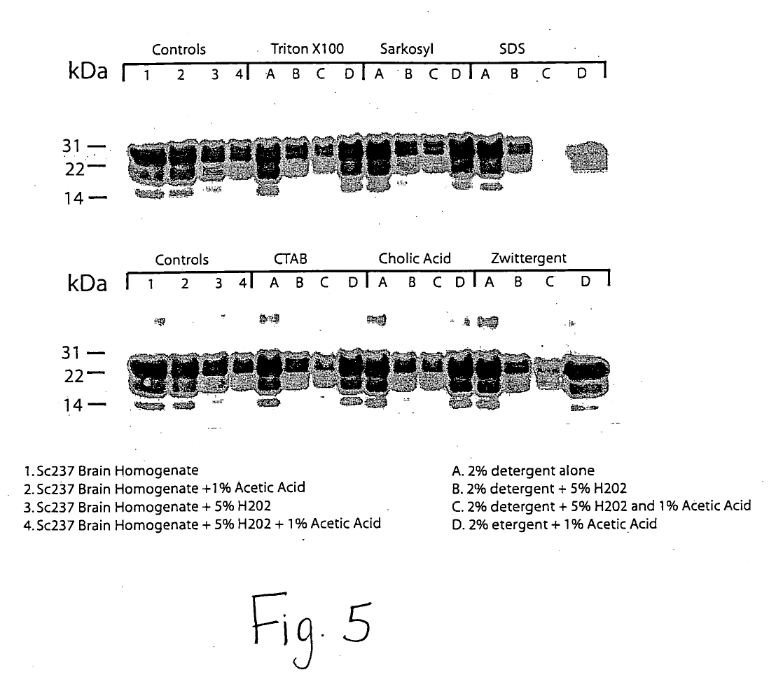

Further experiments were carried out to show the efficacy of HP and other detergents in denaturating PrP^{Sc}. In the experiment Sc237-infected SHa brain homogenates were incubated with one of: A) 2% detergent, B) 2% detergent and 5% HP, C) 2% detergent, 5% HP and 1% acetic acid, and D) 2% detergent and 1% acetic, for 30 min at room temperature. Images of Western Blots of the results are shown in FIG. 5. Acidic SDS denatures most of the PrP^{Sc}, but some residual PrP^{Sc} remains as shown in the Western blot of FIG. 5—compare lanes A, B to lane D. Addition of 5% HP to acidic SDS eliminates all PrP^{Sc} as judged by western blotting after limited proteinase K digestion (FIG. 5, SDS; lane C). In contrast, HP and the detergents Triton X100, Sarkosyl, CTAB, Cholic acid, and Zwittergent each fail to denature PrP^{Sc} effectively in any of these conditions (FIG. 5). These results show that the synergistic effect of H₂O₂ is specific to SDS at low pH.

Formulation of Various Detergents and Peracetic Acid Denature PrP^{Sc}

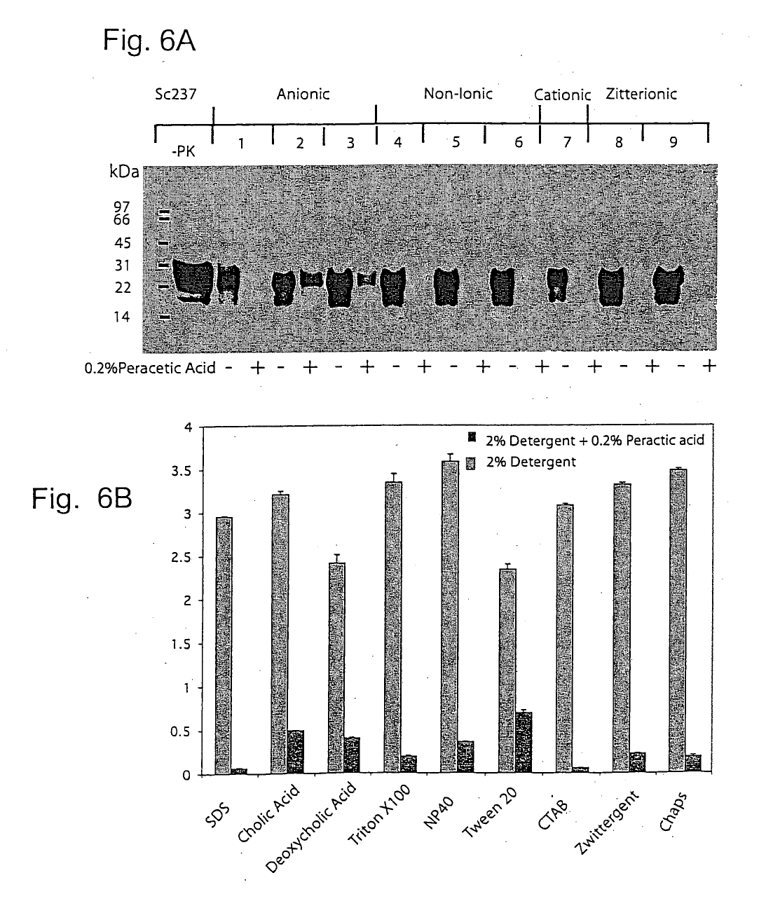

Additional experiments were carried out to show whether the formulation of peracetic acid with detergents other than SDS would denature PrP^{Sc}. In the experiments Sc237-infected SHa brain homogenates were incubated with various detergents, with or without 0.2% peracetic acid, for 30 min at room temperature. FIGS. 6A and 6B show that peracetic acid with SDS denatures PrP^{Sc} in 30 min under these conditions, as judged by Western blot and ELISA following limited proteolysis. There was no detection of PrP^{Sc} after treatment with the cationic detergent CTAB combined with peracetic acid. The levels of PrP^{Sc} were also reduced in homogenates treated with 0.2% peracetic acid and the detergents Cholic acid, Deoxycholic acid, Triton X100, NP40, Tween 20, Zwittergent and CHAPS (See FIGS. 6A and 6B, paired lanes 2 to 9, respectively). These finding show that in the presence of peracetic acid the most potent detergents in denaturating PrP^{Sc} are SDS and CTAB.

Denaturation Efficacy of CTAB and Peroxygenic Solutions

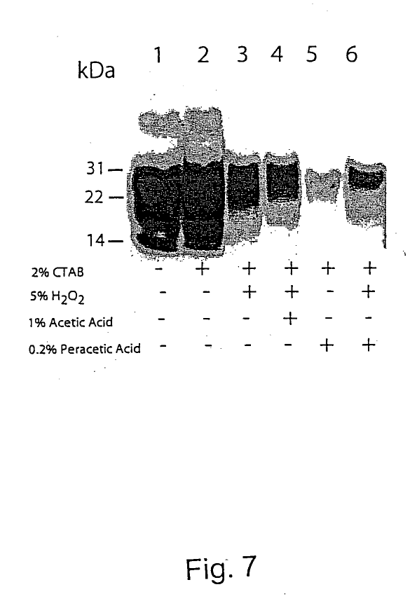

Further experiments were carried out to more thoroughly test the effect of CTAB on PrP^{Sc} at oxidizing conditions. Prion infected brain homogenate were treated with formulations of: 1) CTAB, 2) CTAB and H₂O₂, and 3) CTAB, H₂O₂ and acetic acid. The results are shown in FIG. 7 in lanes 2, 3, 4 respectively showing little effect on PrP^{Sc} as judged by Western blotting after limited proteolysis. Formulations of CTAB at low pH with peracetic acid or H₂O₂ were clearly effective in denaturating PrP^{Sc} as shown in lanes 5 and 6 of FIG. 7.

Prion Strain Discrimination With Peroxygen and Acidic SDS

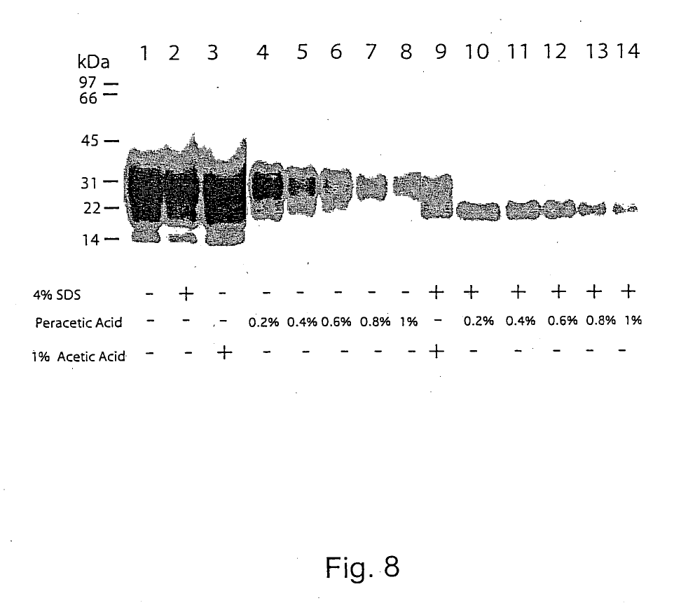

Additional experiments were carried out where Sc237-infected Syrian hamster brain homogenate Sc237 was treated with increasing concentrations of peracetic acid. The results of FIG. 8 show a progressive decrease in the levels of PrP^{Sc} as judged by Western blotting after limited proteolysis. Treatment with 0.2% peracetic acid in the presence of 4% SDS results in stronger denaturation of PrP^{Sc}. The results show that a formulation of 0.2% peracetic acid and SDS is a stronger denaturant than 0.6% peracetic.

PrP^{Sc} is resistant to proteolysis except for the N-terminal region comprising ˜67 residues (Caughey, B. and G. J. Raymond (1991) “The scrapie-associated form of PrP is made from a cell surface precursor that is both protease- and phospholipase-sensitive.” J. Biol. Chem. 266:18217-18223; Gasset, M., M. A. Baldwin, et al. (1993). “Perturbation of the secondary structure of the scrapie prion protein under conditions that alter infectivity.” Proc. Natl. Acad. Sci. USA 90: 1-5.). The protease-resistant fragment of Sc237 PrP^{Sc} has a molecular size of 27-30 kDa and is designated PrP 27-30 [Prusiner, S. B. (1983). On the molecular structure of the scrapie agent. Unconventional Viruses and the Central Nervous System. L. A. Court and F. Cathala. Paris, Masson Editeur: 57-83]. It consists of ˜142 amino acids (residues 90-231) and conveys prion infectivity. Indeed, when prion infected brain homogenates are treated with SDS or various detergents at low pH, the main residual protease-resistant fragment of Sc237 PrP^{Sc} has a molecular weight of 27-30k. Sc237 PrP^{Sc} incubated with H₂O₂ or peracetic at low pH and treated with proteinase K also has a molecular weight of 27-30 kDa as shown in FIGS. 4A and 4B. The results of FIG. 8 show that treatment of prion infected brain homogenates with SDS and oxidizing reagents at low pH, followed by limited proteolysis by proteinase K digestion, results in a residual protease resistant fragment with a molecular weight of ˜22 kDa. This fragment is shown in lane 10-14 of FIG. 8. Evidence of this fragment can also be seen in FIG. 3A lane 9, FIG. 4 lanes 6, 8, 10 and FIG. 6A lane paired lanes 1.

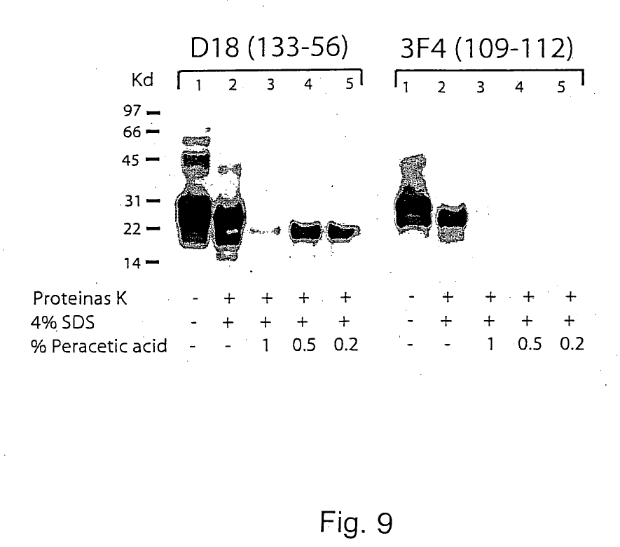

In order to determine the epitope which was denatured Sc237 brain homogenates were treated first with SDS and peracetic acid, followed by PK digestion. Thereafter tests were carried out for the presence of PrP^{Sc} in ELISA with a battery of recombinant Fab antibodies recognizing different epitopes. The following Fabs were used: D13 (epitope; 95-103), 3F4 (epitope; 109-112), 13A5 (epitope; 138-141) D18 (epitope; 133-157), R72 (epitope; 151-162), R1 (epitope; 220-231), and R2 (epitope; 225-231). All samples tested positive for PrP^{Sc} except for those with D13 and 3F4. When these brain homogenates samples were tested with western blotting PrP^{Sc} was clearly detected with D18 but not with 3F4 as shown in FIG. 9. These results show that residues at the N-terminus (at least 90-112) show greater sensitivity to denaturation (compared to the rest of the protease resistant fragment) when acted upon by a combination of acidic SDS and peroxygen compounds.

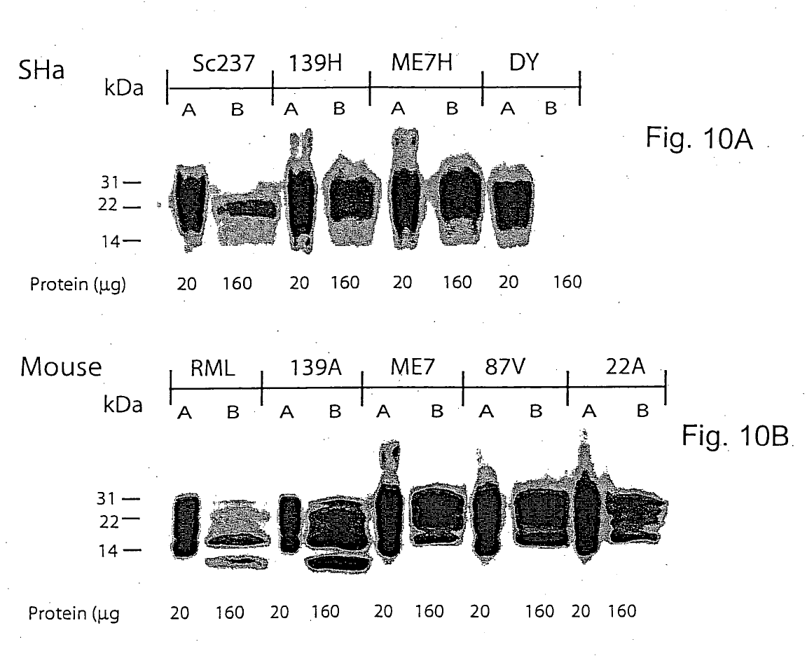

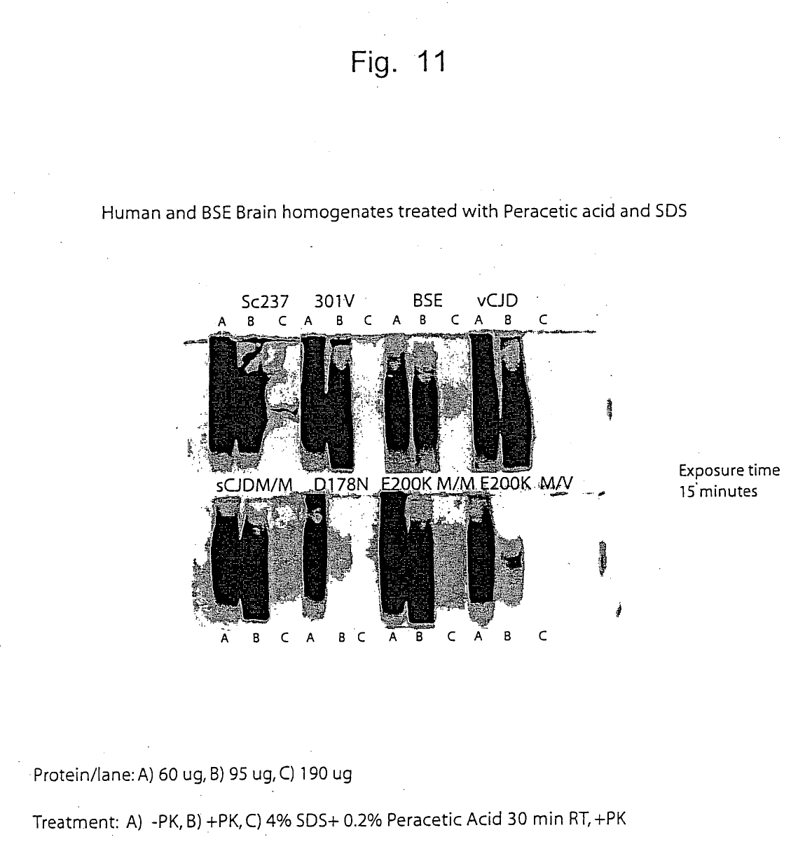

Further experiments were carried out in order to determine whether different strains of prion strains, which contain different conformations of PrP^{Sc}, vary in their susceptibility to SDS/peracetic acid effect on the N-terminus. Homogenates were prepared from brains of Syrian hamster inoculated with either Sc237, 139H, Me7H or DY prions and from brains of mice inoculated with either with RML, 139A, Me7, 87V, and 22A prion. When treated with SDS and peracetic acid for 30 min at room temperature all PrP^{Sc} strains were denatured as judged by western blotting using D18 after proteinase K. In order to visualize the residual PrP^{Sc} from treated homogenates, it was necessary to load 100 μg of protein per lane. From non-treated samples only 20 μg protein was loaded. The results show that treated Syrian hamster strains 139H and Me7H as well as mice strains Me7, 22A and 22V had a MW of 27-30 kDa—see FIG. 10. Syrian hamster Sc237 FIG. 10A, and mouse RML FIG. 10B, as well as 139A had a MW of 22 kDa. The results indicate that the increase susceptibility of residues 90-112 to denaturation by peracetic SDS is dependent on the conformation of prion strain. Accordingly, the susceptibility can be used to differentiate between strains of PrP^{Sc}. It is important to emphasis that the majority of PrP^{Sc} molecules are fully denatured regardless of the strain of species. The results also show in FIG. 11 that treatment for 30 min at room temperature with peracetic acid and SDS denatures PrP^{Sc} of all tested prion strains including mouse 301V, bovine BSE, vCJD, sporadic CJD and different familial CJD cases. Similar treatment of scrapie sheep brain homogenate resulted in the elimination of all PrP^{Sc}. The strong denaturation effect of peracetic acid combined with SDS does not at this time make it possible to determine the molecular weight of residual PrP^{Sc} from these prion strains.

Mechanism of Prion Disinfection

The combination of SDS and acetic acid denatures PrP^{Sc} and reduces prion infectivity in brain homogenates and prion-coated stainless steel wires. When used alone 3% Hydrogen peroxide does not reduce prion infectivity {Brown, P., R: G. Rohwer, et al. (1982). “Effect of chemicals, heat, and histopathologic processing on high-infectivity hamster-adapted scrapie virus.” J. Infect. Dis. 145: 683-687}. It has also been shown that 2% peracetic acid will inactivate the infectivity in intact brain tissue {Taylor, D. M. (1991). “Resistance of the ME7 scrapie agent to peracetic acid.” Vet Microbiol 27: 19-24.}. However, none of the concentrations of peracetic acid tested (19% up to 24 h) was effective in order to inactivate the infectivity of brain homogenates. The results provided here show that treatment of prion infected brain homogenates with a formulation of 0.2% peracetic acid and SDS denatures most of the PrP^{Sc} in brain homogenates. As peracetic acid is acetic acid plus oxygen the results show that oxidation synergies with SDS at low pH to denature PrP^{Sc}. This is confirmed by other results showing that another oxidizing agent (hydrogen peroxide, H₂O₂) in the presence of SDS and acetic acid is as robust as a denaturant as compared to peracetic acid combined with SDS. Results provided here shows that a solution of peracetic acid, H₂O₂ and SDS is more robust than any combinations of two of these components.

Hydrogen peroxide and peracetic acid in the presence of metal ions lead to the production of highly toxic hydroxyl radical [Block, S. S. (2001). Peroxygen compounds. Disinfection, Sterilization, and Preservation. S. S. Block. Philadelphia, Lippincott Williams & Wilkins: 185-204.]. The hydroxyl radical is said to be the strongest oxidant known. Hydroxyl radical, being highly reactive, can attack proteins, lipids, and DNA. Hydroxyl radicals can also oxidize Sulfhydryl groups and double bonds present in a protein. The presence of iron and copper in the brain promote the formation free radicals. This shows that denaturation of PrP^{Sc} by this formulation is mediated by the synergistic effect of SDS, low pH, and oxidation. The likely mechanism of action is a combination of the protonation of PrP^{Sc}, by the low pH, altering its conformation in such a way as to expose the hydrophobic core of the protein to SDS mediated denaturation and attack by hydroxyl free radicals.

The results of the present invention also show that a combination of the cationic (positively charge) detergent Cetyltrimethylammonium bromide (CTAB), which belongs to a chemical group defined as Quaternary ammonium compounds and peracetic acid denatures PrP^{Sc}. The mechanism of action of this detergent is unknown at this stage. The presence of bromide ions could catalyze the formation of reactive bromide hydroxyl radicals; reaction: OH+Br⁻→BrOH⁻.

### Combination Treatment

The invention may be used in combination with traditional instrument sterilization methods. Those methods include the use of ethylene oxide gas (EtO) and steam as well as a method using low-temperature hydrogen peroxide gas plasma or a combination of both of these methods. The method may use a combination of hydrogen peroxide vapor and low-temperature gas plasma to rapidly sterilize medical instruments without leaving toxic residues. This technology may be carried out without the limitations or risks associated with peracetic acid, steam, and ethylene oxide gas (EtO) systems.

The present invention may be used in combination with a method that is particularly suited to heat-sensitive and moisture-sensitive instruments, which method includes 5 phases:

1. The Vacuum Phase

A chamber with instruments to be sterilized and with a formulation of the invention thereon is evacuated, reducing internal pressure in preparation for the subsequent reaction. Because the next step uses hydrogen peroxide the formulation of the invention may be comprised only of SDS, or SDS and an acid component such as acetic acid.

2. The Injection Phase

A measured amount of liquid peroxide is injected into the chamber, evaporating the aqueous hydrogen peroxide solution and dispersing it into the chamber, where it contacts proteins (e.g. prions) and any microorganism (bacteria, virus or fungus) on any surface of the instruments.

3. The Diffusion Phase

The hydrogen peroxide vapor permeates the chamber, exposing all load surfaces to the sterilant and rapidly sterilizes devices and materials without leaving any toxic residues. At the completion of this phase, the chamber pressure is reduced and the plasma discharge is initiated.

4. The Plasma Phase

An electromagnetic field is created in which the hydrogen peroxide vapor breaks apart, producing a low-temperature plasma cloud that contains ultraviolet light and free radicals. Following the reaction, the activated components lose their high energy and recombine to form oxygen and water.

Phases 1, 2, and 3 may be run a second time or a plurality of times for added efficacy. This built-in reprocessing assures optimal sterilization for even the most difficult-to-sterilize devices.

5. The Vent Phase

The chamber is vented with filtered air to equalize the pressure enabling the chamber door to be opened. There is no need for aeration or cool-down. Devices are ready for immediate use.

FORMULATION 1

| Component | wt % |
|---|---|
| Water | 10-98 |
| Acid | 1-20 |
| Detergent | 1-20 |
| Hydrogen peroxide | 0.01-5 |

FORMULATION 2

| Component | wt % |
|---|---|
| Water | 10-98 |
| Acetic acid | 1-20 |
| Linear alkyl Sulfonate | 1-20 |
| Hydrogen peroxide | 0.01-5 |

FORMULATION 3

| Component | wt % |
|---|---|
| Water and Hydrogen | 10-99 |
| peroxide | |
| Acetic acid | 1-20 |
| SDS | 0.01-10 |

FORMULATION 4

| Component | wt % |
|---|---|
| Water | 1-98 |
| Alcohol | 0-98 |
| Acid | 1-20 |
| Detergent | 1-20 |
| Hydrogen peroxide | 0.1-5 |

FORMULATION 5

| Component | wt % |
|---|---|
| Water | 1-99 |
| Acid | 1-20 |
| Hydrogen peroxide | 0.1-5 |
| CTAB | 1-20 |

FORMULATION 6

| Component | wt % |
|---|---|
| Water | 3-98.889 |
| Antimicrobial active Agent | 0.001-5 |
| Acetic acid | 1-80 |
| CTAB | 0.1-12 |
| Hydrogen peroxide | 0.01-5 |

FORMULATION 7

| Component | wt % |
|---|---|
| Hydrogen peroxide | 0.5 |
| Ethanol | 74.0 |
| SDS | 0.02 |
| Acetic acid | 10.0 |
| Purified water | 13.3 |

FORMULATION 8

| Component | wt % |
|---|---|
| Water | 3-98.889 |
| SDS | 1-80 |
| Acetic acid | 0.1-12 |
| Hydrogen peroxide | 0.01-5 |

FORMULATION 9

| Component | wt % |
|---|---|
| Sodium Acetate pH | 10% |
| 4.0 ± 1 | |
| SDS | 4% |
| Water and hydrogen | 86% |
| peroxide | |

FORMULATION 10

| Component | wt % |
|---|---|
| SDS | 4% |
| Peracetic acid | 0.1-10% |
| Water | 86-95.9% |
| Hydrogen peroxide | 6% |

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

### Effect of SDS, Acidic pH, and Temperature on Prion Infectivity

Samples of 1% Sc237-infected SHa brain homogenate containing 10⁷ ID₅₀ units prion infectivity/ml were incubated with continuous shaking for 2 h in the specified buffer at the indicated temperature. Following incubation, samples were diluted 1:10 into PBS without calcium or magnesium plus 5 mg/ml BSA, and 50 μl aliquots were inoculated into 8 separate Syrian hamsters. The results are plotted in FIG. 1 where the filled triangles are data for 1% NP40; 50 mM Tris Acetate, pH 7.0 at 37° C.; the filled circles are data for 1% NP40; 0.5% acetic acid, pH 3.6 at 37° C.; the open triangles are data for 1% SDS; 50 mM Tris Acetate, pH 7.0 at 37° C.; the closed squares are data for 1% SDS; 0.5% acetic acid, pH 3.6 at 20° C.; and the open circles are data for 1% SDS; 0.5% acetic acid, pH 3.6 at 37° C.; (open squares) 1% SDS; 0.5% acetic acid, pH 3.6 at 65° C.

### Example 2

### Effect of Detergent and pH on Protease-Resistant PrP^{SC}

Samples of 1% Sc237-infected SHa brain homogenate were incubated for 15 min at 37° C. with detergent at the range of pH values indicated. Fifty mM sodium acetate buffers were used to maintain pH values 3 to 6, and 50 mM Tris acetate buffers were used to maintain pH values 7 to 10. The final pH value of each sample denoted above each corresponding lane was measured directly with a calibrated pH electrode (Radiometer Copenhagen). Following incubation, all samples were neutralized by the addition of an equal volume of 4% Sarkosyl; 100 mM HEPES, pH 7.5; 200 mM NaCl and subjected to limited proteolysis with 20 μg/ml proteinase K for 1 h at 37° C. These results are shown in FIG. 2A.

Samples of 1% Sc237-infected SHa brain homogenate were incubated for 15 min at 37° C. in 1% SDS plus (1) 50 mM Tris acetate, pH 7.0; (2) 0.5% acetic acid, pH 3.6; (3) 50 mM glycine, pH 3.7; or (4) 0.2% peracetic acid (Sigma-Aldrich), pH 3.4. Following incubations, all samples were neutralized and proteinase K digested as described above for FIG. 2A. The results are shown in FIG. 2B.

Samples of 2.5% Sc237-infected brain homogenate were incubated with 4% detergent with (+) or without (−) 1% acetic acid at room temperature for 30 min. Lane pair assignments are as follows: (1) SDS; (2) Cholic Acid; (3) Deoxycholic Acid; (4) Triton X100; (5) NP40; (6) Tween 20; (7) CTAB; (8) Zwittergen; (9) Chaps. All paired samples (lanes 1-9) were neutralized by the addition of eight volumes of 4% Sarkosyl; 100 mM HEPES, pH 7.5; 200 mM NaCl and were subjected to limited proteolysis with 20 μg/ml proteinase K for 1 h at 37° C. The results are shown in FIG. 2C. For all of FIGS. 1A, 2B and 2C the apparent molecular weights based on migration of protein standards are 30 and 27 kDa.

### Example 3

Samples of 20% Sc237-infected brain homogenate (10 μl/200 μg) were incubated with (+) or without (−) the following reagents; 1) 4% SDS, 2) different concentrations of H₂O₂, 3) 1% acetic acid, and 4) 0.2% peracetic acid at room temperature for 30 min to a final volume of 40 μl. Samples (lanes 1-9 of FIG. 3A) were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. Western blots were loaded with 24 μl/lane and the results are shown in FIG. 3A.

280 μl were treated with 1.120 ml of methanol/chloroform and PrP^{Sc} was analyzed with ELISA as described previously [Peretz, D., R. A. Williamson, et al. (2002). “A change in the conformation of prions accompanies the emergence of a new prion strain.” Neuron 34: 921-932 and Peretz, D., R. A. Williamson, et al. (2002). Antibodies inhibit prion formation and abolish prion infectivity. Transmissible Spongiform Encephalopathies: New Perspectives for Prion Therapeutics, Paris, France, Editions de Condé. and the results are shown in FIG. 3B.

PrP^{Sc} in FIGS. 3A and 3B were detected with Fab D18.

### Example 4

Samples of 10% Sc237-infected brain homogenate (20 μl/200 μg) were incubated with (+) or without (−) the following reagents; 1) 5% H₂O₂, 2) 0.2% peracetic acid, 3) 2% SDS, and 4) 1% acetic acid, at room temperature for 30 min to final volume of 40 μl. Samples (lanes 1-10) were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. Western blots were loaded with 100 μl/lane and PrP^{Sc} was detected with Fab D18. Blot was exposed to detection films for 15 seconds as shown in FIG. 4A and thereafter for 10 min. as shown in FIG. 4B.

### Example 5

10 μl samples of 20% Sc237-infected brain homogenate were incubated with: A) 2% detergent, B) 2% detergent, 5% H₂O₂, C) 2% detergent, 5% H₂O₂, 1% acetic acid and D) 2% detergent, 1% acetic acid. Controls homogenates were treated with: 1) PBS, 2) 1% acetic acid, 3) 5% H₂O₂, and 4) 1% acetic acid and 5% H₂O₂. Samples were diluted and PrP^{Sc} was detected with Western blotting using D18 recFab as described in Example 4 above and the results are shown in FIG. 5.

### Example 6

10 μl samples of 20% Sc237-infected brain homogenate were incubated with 2% detergent with (+) or without (−) 1% peracetic acid at room temperature for 30 min. Lane pair assignments are as follows: (1) SDS; (2) Cholic Acid; (3) Deoxycholic Acid; (4) Triton X100; (5) NP40; (6) Tween 20; (7) CTAB; (8) Zwittergen; (9) Chaps. All paired samples (lanes 1-9) were neutralized with 280 μl of neutralization buffer to final concentration of 2% Sarkosyl; 200 mM HEPES, pH 7.5; 100 mM NaCl and were subjected to limited proteolysis with 4 μg proteinase K for 1 h at 37° C. The results are shown in FIG. 6A in which the Western blots were loaded with 24 μl/lane. For FIG. 6B 280 μl were treated with 1.120 ml of methanol/chloroform and PrP^{Sc} was analyzed with ELISA as described previously [Peretz, 2002 #5885].

PrP^{Sc} in FIGS. 6A and 6B were detected with recFab D18.

### Example 7

Samples of 10% Sc237-infected brain homogenate (20 μl/200 μg) were incubated with (+) or without (−) the following reagents; 1) 5% H₂O₂, 2) 0.2% peracetic acid, 3) 2% CTAB, and 4) 1% acetic acid, at room temperature for 30 min to final volume of 40 μl. Samples were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. For FIG. 7 Western blots were loaded with 100 μl/lane and PrP^{Sc} was detected with Fab D18

### Example 8

10 μl samples of 20 % Sc237-infected brain homogenate were incubated with (+) or without (−) the following reagents: 1) 4% SDS, 2) increasing concentrations of peracetic acid, and 3) 1% acetic acid. Samples were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. For FIG. 8 Western blots were loaded with 24 μl/lane and PrP^{Sc} was detected with recFab D18.

### Example 9

10 μl samples of 20% Sc237-infected brain homogenate were incubated with (+) or without (−) the following reagents: 1) proteinase K, 2) 4% SDS, and 3) different concentrations of PA. Samples were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. For FIGS. 9A and 9B Western blots were loaded with 24 μl/lane and PrP^{Sc} was detected with recFab D18 for FIG. 9A and with mAb3F4 for FIG. 9B.

### Example 10

Brain homogenates were prepared from brains of Syrian hamster inoculated in FIG. 10A results with one of Sc237, 139H, Me7H or DY prions and for FIG. 10B the brains of mice inoculated with one of RML, 139A, Me7, 87V, or 22A prion. 10 μl samples of 20% prion-infected brain homogenate were incubated with; (A) 2% Sarkosyl or with (B) 4% SDS and 0.2% PA for 30 min at RT. Samples were diluted with 280 μl of neutralization buffer to final concentration of 100 mM NaCl, 2% Sarkosyl and 200 mM HEPES pH 7.5 and were subjected to limited proteolysis with 4 μg proteinase K for 1 h at 37° C. Western blots were loaded with 24 μl/lane and PrP^{Sc} was detected with recFab D18.

### Example 11

Brain homogenates were prepared from brains of 1) Syrian hamster inoculated with Sc237 prions, 2) mouse inoculated 301V prions, 3) Bovine Spongiform Encephalopathy (BSE), 4) variant CJD patient, 5) sporadic CJD patient, M128M, 6) human fatal familial insomnia (FFI) patient D178N, 7) familial CJD patient E200K, M128M, and 8) familial CJD patient E200K, M128V. Samples of 10% brain homogenates were treated with; (A and B) none, (C) 4% SDS and 0.2% peracetic for 30 min at RT. Samples were diluted with 280 μl of neutralization buffer to final concentration of 100 mM NaCl, 2% Sarkosyl and 200 mM HEPES pH 7.5 and samples B and C were subjected to limited proteolysis with 4 μg (20 μg/ml) proteinase K for 1 h at 37° C. Western blots were loaded with various amounts of brain homogenate and were detected with mAb 6H4.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A formulation, comprising:
a denaturing detergent;
a weak acid maintaining the formulation pH at about 4.0 or less; and
a chemical modification reagent.

2. The formulation of claim 1, wherein the detergent is an alkyl salt of sulfuric acid and the weak acid is chosen from the acetic acid and peracetic acid and the chemical modification reagent is hydrogen peroxide.

3. The formulation of claim 1, wherein the detergent is cetylmethylammonium bromide (CTAB) and the weak acid is chosen from the acetic acid and peracetic acid and the chemical modification reagent is hydrogen peroxide.

4. The formulation of claim 1, further comprising:
a solvent chosen from water and an alcohol and the chemical modification reagent is hydrogen peroxide and the detergent is sodium dodecyl sulfate (SDS).

5. The formulation of claim 4, wherein the solvent is water and the weak acid is chosen from acetic acid, peracetic acid, perfomic acid, iodoacetic acid, nitrous acid, p-sulfondichloramindobenzoic acid, trichloro-isocyanuric acid, and dichloro-isocyanuric acid.

6. The formulation of claim 4 wherein the solvent is an alcohol chosen from ethanol and methanol and the weak acid is chosen from acetic acid, peracetic acid, perfomic acid, iodoacetic acid, nitrous acid, p-sulfondichloramindobenzoic acid, trichloro-isocyanuric acid, and dichloro-isocyanuric acid.

7. The formulation of claim 1, wherein the weak acid is chosen from acetic acid and peracetic acid and the chemical modification reagent is hydrogen peroxide.

8. A formulation, comprising:
a detergent chosen from sodium dodecyl sulfate (SDS) and cetylmethylammonium bromide (CTAB);
a weak acid chosen from peracetic acid and acetic acid; and
hydrogen peroxide.

9. The formulation of claim 8, wherein the hydrogen peroxide is in a form chosen from liquid, gaseous and plasma.

10. A method of rendering an infectious protein completely non-infectious, comprising:
contacting infectious proteins with a salt of an alkyl sulfate or sulfinate for a time and under conditions to allow for a change in the infectious proteins conformation to a non-infectious conformation;
chemically modifying the proteins in the non-infectious conformation which inhibits the protein from assuming an infectious conformation so as to render the proteins completely non-infectious.

11. The method of claim 10, wherein the proteins are prions and conditions comprise a temperature in a range of about 10° C. to about 80° C.

12. The method of claim 10, wherein the time is about two hours or less.

13. The method of claim 10, wherein the proteins are prions comprised of amino acids which are comprised of side chains and the chemical modification results in oxidation of at least some side chains.

14. A method of rendering prions non-infectious, comprising the steps of:
contacting prions with a detergent which changes the prion conformation;
contacting the prion with a chemical modification reagent chosen from
Hydrogen Peroxide
N-Succinimdyl propionate
Diethylpyrocarbonate
Formaldehyde
Glutaraldehyde
Iodine
Maleic anhydride
Dithiothreitol (DTT)
Sodium borohydride
Succinic anhydride
Acetic anhydride
Maleic anhydride
Sulfonyl halides
Carbodiimide
Diazonium salts
Iodoacetate
Sulfites
Phosphorothioate
5,5′-Dithiobis(2-Nitrobenzoic acid) (DTNB)
Iodosobenzoate
Tetrathionate
N-bromosuccinamide (NBS)
N-bromoacetamide
Tetranitromethane
Cyanogen bromide
Hypochlorites
Chlorinated trisodium phosphate
Chlorine dioxide
N,N′-dichloroazodicarbonamidine
Sulfonchloramide
Succinchlorimide
1,3-Dichloro-5,5-dimethylhydantoin
Trichloromelamine
Ozone
Chlorine
Phenylglyoxal
Nitriles
Pyridines
Thiazoles
Ortho-phthaldehyde
Nitric oxide
Beta-propiolactone
N-ethylmaleimide; and
allowing the prions to remain in contact with the chemical modification reagent for a time of two hours or less at a temperature sufficient to chemically modify the prions rendering the prions completely non-infectious.

15. The method of claim 14, wherein the detergent is an aqueous formulation comprising 0.25% or more of an alkyl salt of a sulfur containing acid.

16. The method of claim 15, wherein the alkyl salt is a salt of a cation of a metal selected from the group consisting of sodium, calcium and magnesium, the acid sulfuric acid and the alkyl group comprises about 6 to 14 carbon atoms.

17. The method of claim 15, wherein the alkyl salt of an acid is sodium dodecyl sulfate.

18. The method of claim 14, wherein the period of time to render the protein completely non-infectious is one hour or less and wherein the prions are further contacted with a weak acid.

19. The method of claim 14, wherein the detergent is cetylmethylammonium bromide (CTAB) completely non-infectious is one hour or less.

20. The method of claim 14, wherein the chemical modification occurs at a pH selected from the group of ranges consisting of (a) less than 5.0 and (b) more than 9.0.

21. The method of claim 18, wherein the chemical modification occurs at a pH in a range of from about 2.5 to about 4.0.

22. The method of claim 16, wherein the group is comprised of from 2 to 40 carbon atoms.

23. The method of claim 16, wherein the alkyl group is comprised of from 8 to 12 carbon atoms.

24. The method of claim 14, wherein the temperature is in a range of from about 15° C. to about 70° C.

25. The method of claim 14, wherein the temperature is about 30° C.±15° C.

26. The method of claim 15, wherein the formulation comprises 1% or more of the alkyl salt.

27. The method of claim 15, wherein the formulation comprises 3% or more of the alkyl salt.

28. A method of sterilizing a surface of an article, comprising the steps of:
evacuating air from a chamber having an article to be sterilized therein;
injecting a liquid formulation into the chamber, the liquid comprising peroxide, a detergent and an acid;
allowing the formulation to contact the article;
creating an electromagnetic field in the chamber producing a low-temperature plasma cloud of the formulation;
venting the chamber and removing the article.

29. The method of claim 28, wherein the acid of the formulation is chosen from acetic acid and peracetic acid and the detergent is chosen from sodium dodecyl sulfate (SDS) and cetylmethylammonium bromide (CTAB).
